(19) United States
(12) Patent Application Publication
(10) Pub. No.: US 2026/0241636 A1
(43) Pub. Date: Aug. 20, 2026

(54) COMBINATION ADDITIVE AND SUBTRACTIVE MANUFACTURING METHODS AND APPARATUS FOR LIGHT POLYMERIZABLE RESINS

(71) Applicant: CARBON, INC., Redwood City, CA (US)

(72) Inventors: Matthew PANZER, Redwood City, CA (US); Anant CHIMMALGI, Los Altos, CA (US)

(21) Appl. No.: 19/162,180

(22) PCT Filed: Mar. 22, 2024
(86) PCT No.: PCT/US2024/021042

§ 371 Date: Sep. 4, 2025

Related U.S. Application Data
(60) Provisional application No. 63/491,619, filed on Mar. 22, 2023.

(51) Int. Cl. B29C 64/129; B29C 64/188; B29C 64/218; B29C 64/277; B29C 64/393; B33Y 10/00; B33Y 30/00; B33Y 40/00; B33Y 50/02; B33Y 70/10

(52) U.S. Cl. CPC B29C 64/129; B29C 64/188; B29C 64/218; B29C 64/277; B29C 64/393; B33Y 10/00; B33Y 30/00; B33Y 40/00; B33Y 50/02; B33Y 70/10

(57) ABSTRACT

Provided according to embodiments of the invention are methods of method of making a three-dimensional object by additive manufacturing that include exposing excess material (13a) on a three-dimensional object to an ablation/laser light (42) at a dosage sufficient to remove said excess material; exposing a build surface of a three-dimensional object to an ablation/laser light to physically and/or chemically modify the build surface; and/or exposing a portion of a resin coated film to ablation/laser light sufficient to eject resin onto a bottom surface of the three-dimensional object. Related apparatuses are also provided.

### RELATED APPLICATIONS

This application claims priority from U.S. Provisional Application Ser. No. 63/491,619, filed Mar. 22, 2023, the disclosure of which is hereby incorporated by reference in its entirety.

### FIELD

Additive manufacturing methods and apparatus are described herein, particularly methods and apparatus for forming a three-dimensional object from a polymerizable resin.

### BACKGROUND

A variety of additive manufacturing methods in which a 3D object is formed from a viscous, light polymerizable, resin are known. Examples include methods (and corresponding apparatus) in which the resin is applied to a movable, light transmissive, film, or applied by a roller to a build surface of the growing 3D object, to bring sequential slices of resin into a “build zone” and form a new region of unpolymerized resin (i.e., a “build segment”). Patterned light is then being projected through the film or onto the roller-applied region, in a bottom-up or top-down fashion, to polymerize the build segment, again in a sequential manner, and form the 3D object (see, for example, U.S. Pat. Nos. 11,192,302; 10,792,868; 9,862,146; 8,905,739; 5,650,260; and 5,637,169; see also PCT Publication No. WO2021/180997 of BCN3D).

A problem with such approaches is that, once the 3D object is formed, residual resin is retained on the surface thereof in an inconsistent or uneven manner, and hence must be removed by a cleaning process such as washing or centrifugal separation. In many cases, the more viscous the resin (and high viscosity resins are for some uses preferred), the more aggressive the cleaning process must be. Not only does this add an additional (potentially time consuming and cumbersome) step to the manufacturing process, but the cleaning process itself may damage the 3D object by extracting key chemical constituents from the object by a wash liquid, the application of physical forces to the object, or a combination thereof. Accordingly, new approaches to additive manufacturing with polymerizable resins that do not require aggressive post-production cleaning steps are needed.

### SUMMARY

Embodiments of the present invention are directed methods of making a three-dimensional object by additive manufacturing. In some embodiments, the method includes (a) applying a light polymerizable resin to a build surface of a growing three-dimensional object to form a build segment, the applying carried out with a moving roller resin applicator or a moving film resin applicator; (b) exposing the build segment to patterned light to polymerize the build segment and form a new build surface, the new build surface having edge portions, the edge portions carrying excess, polymerized or unpolymerized, material thereon; (c) exposing the excess material to an ablation light (e.g., laser light) at a dosage (i.e., an exposure pattern, wavelength, intensity and duration) sufficient to remove the excess material from the edge portions (e.g., by ablation or melting); and (d) sequentially repeating steps (a) through (c), with step (c) optionally omitted during some of the sequentially repeating steps but included during at least a plurality of the sequentially repeating steps, until the three-dimensional object is formed.

In some embodiments, the excess material includes polymerized resin.

In some embodiments, the excess material includes unpolymerized resin.

Additional embodiments of the present invention are directed to methods of making a three-dimensional object by additive manufacturing. In some embodiments, the method includes (a) applying a light polymerizable resin to a build surface of a growing three-dimensional object to form a build segment, and with the applying carried out with a moving roller resin applicator or a moving film resin applicator; (b) exposing the build segment to patterned light to polymerize the build segment and form a new build surface, (c) exposing the new build surface to an ablation light (e.g., laser light) to physically and/or chemically modify the new build surface; and (d) sequentially repeating steps (a) through (c), with step (c) optionally omitted during some of the sequentially repeating steps but included during at least a plurality of the sequentially repeating steps, until the three-dimensional object is formed.

In some embodiments, the exposing step (c) is carried out at a dosage (i.e., an exposure pattern, wavelength, intensity and duration) that textures at least a portion (e.g., a major portion) of the new build surface (e.g., the pattern configured to enhance adhesion of a subsequent build segment to the new build surface).

In some embodiments, the light polymerizable resin includes an additive (e.g., a thermoplastic material such as nylon powder, a natural or synthetic rubber, ceramic particles, etc.), and the exposing step (c) is carried out at a dosage (i.e., an exposure pattern, wavelength, intensity and duration) that selectively melts or sinters the additive (e.g., to form a co-continuous secondary material network) in at least a portion (e.g., a major portion) of the new build surface and modify the material properties of the three-dimensional object (e.g., such as increase toughness, and/or promoting interlayer adhesion, strength or toughness).

In some embodiments, the light polymerizable resin is a dual cure resin including a first polymerizable component and a second polymerizable component and the exposing step (c) is carried out at a dosage (i.e., an exposure pattern, wavelength, intensity and duration) that initiates polymerization of the second polymerizable component in at least a portion (e.g., a major portion) of the new build surface to modify the mechanical properties of the three-dimensional object (e.g., in the green and/or final steps) (in some embodiments theses exposure dosages may be patterned, spatially and/or temporally, to create control of and modify the spatial distribution of material properties in the three-dimensional object).

In some embodiments, the exposing step (c) is carried out at a dosage (i.e., an exposure pattern, wavelength, intensity and duration) that modifies material properties (e.g., modifies glass transition temperature) in at least a portion (e.g., a major portion) of the new build surface (e.g., to modify internal stresses in the object and thereby modify final object geometry).

In some embodiments, the exposing step (c) is carried out at a dosage (i.e., an exposure pattern, wavelength, intensity and duration) that activates surface chemicals (e.g., modifies glass transition temperature) in at least a portion (e.g., a major portion) of the new build surface (e.g., to promote adhesion, modify the surface energy, and/or control the wettability of the resin.

In some embodiments, the light polymerizable resin includes a filler (e.g., a porogen or microballoon), and the exposing step (c) is carried out at a dosage (i.e., an exposure pattern, wavelength, intensity and duration) that selectively expands the filler (e.g., to thereby counteract shrinkage and/or warpage of the object) in at least a portion (e.g., a major portion) of the new build surface.

In some embodiments, the light polymerizable resin includes a filler (e.g., solid fillers including fiber fillers, spherical fillers, elliptical fillers, etc.).

In some embodiments, the filler is a solid particulate filler including glass fibers, carbon fibers, aramid fibers, basalt fibers, thermoplastic or thermoset polymer fibers (e.g., polyamide, cellulose, or nanocellulose fibers, etc.).

In some embodiments, the light polymerizable resin has a viscosity of 1,000, 2,000, 10,000 or 20,000 centipoise or more at 25 degrees Centigrade and 1 atmosphere pressure.

In some embodiments, the light polymerizable resin has a viscosity of from 100,000 centipoise to 1,000,000 or 2,000,000 centipoise or more, at 25 degrees Centigrade and 1 atmosphere pressure.

In some embodiments, the applying step is carried out with a bottom-up or top-down additive manufacturing apparatus.

In some embodiments, the applying step is carried out with a moving roller resin applicator.

In some embodiments, the applying step (a) is carried out with the moving film resin applicator (e.g., where the moving film is a light-transmissive film, through which the patterned light, and optionally the ablation light, is projected).

In some embodiments, the ablation light is a laser light.

In some embodiments, the laser light is at a dosage which is absorbed by the excess material and/or the new build surface in single photon or multiphoton absorption process.

In some embodiments, the laser light is delivered to the excess material and/or the new build surface as a shaped beam.

In some embodiments, the laser light is delivered to the excess material and/or the new build surface as a continuous wave or pulsed laser beam.

In some embodiments, the method further includes the steps of detecting a current property (e.g., focal field, focal length, wavelength, intensity) of the ablation light; comparing the current property to a desired property (e.g., focal field, focal length, wavelength, intensity) and modifying the ablation light so that the current property more closely corresponds to the desired property.

Additional embodiments of the present invention are directed to a three-dimensional object produced by the methods described herein.

Additional embodiments of the present invention are directed to an apparatus for additively manufacturing a three-dimensional object from a light polymerizable resin. The apparatus includes (a) a build platform on which a growing three-dimensional object can be produced, the object having a build segment, the build segment including an edge portion and a build surface; (b) an applicator configured to apply a light-polymerizable resin to the build surface to form a new build segment including a new edge portion and a new build surface, wherein the applicator includes a moving roller resin applicator or a moving film resin applicator; (c) a resin supply configured for applying the light polymerizable resin to the applicator; (d) a first, additive light source configured for polymerizing the light polymerizable resin on the build segment; and (e) a second, subtractive light source configured for delivering a dosage of light to the edge portion(s) and/or the build surface(s).

In some embodiments, the subtractive light source includes an ultraviolet (UV) light source, vacuum UV light source, deep UV light source, or and high intensity infra-red (IR) light source.

In some embodiments, the subtractive light source includes a laser (e.g., a gas laser, a solid-state laser, a fiber laser, a liquid laser, or a semiconductor laser).

In some embodiments, the applicator includes the moving roller resin applicator.

In some embodiments, the applicator includes the moving film resin applicator.

In some embodiments, the moving film resin applicator is light-transmissive and the first light source projects through the moving film resin applicator.

In some embodiments, the subtractive light source projects through the moving film resin applicator.

In some embodiments, the subtractive light source does not project through the moving film resin applicator (e.g., by positioning on the opposite side of the moving film resin applicator from the additive light source, or by positioning adjacent the moving film resin applicator where the moving film resin applicator is not between the build platform and/or growing three-dimensional object).

In some embodiments, the apparatus further includes a detector operatively associated with the subtractive light source and configured to detect a current property (e.g., focal field, focal length, wavelength, intensity) of the subtractive light; and a controller operatively associated with the detector and the subtractive light source, the controller configured to compare the current property to a desired property (e.g., focal field, focal length, wavelength, intensity) and modify the subtractive light so that the current property more closely corresponds to the desired property.

In some embodiments, the subtractive (e.g., laser) light source include a continuous wave light source or a pulsed laser light source; a single beam light source or a multi-beam light source, a free-standing laser or a fiber-optic based laser; and/or a single wavelength light source or a multi-wavelength light source.

In some embodiments, the subtractive (e.g., laser) light source further includes a laser trepanning system; an XY stage for scanning or raster scanning of the laser beam; a beam expander, mirror, focusing lens, and/or air assist; a Z focusing component such as a motorized focusing mechanism; an additional optical element including a fiber optic element, diffraction optical elements and/or beam splitter; a beam focusing elements (e.g., an to f-theta lens, motor driven z-focusing component, etc.); and/or a beam shaping components (e.g., a refractive beam shaping element, diffractive beam shaping element, laser beam integrators, axicons for generating Bessel beams, cylinder lenses and anamorphic prism pairs for circularizing beams, etc.).

Laser ablation of polymers is discussed in S. Ravi-Kumar et al., Procedia Manufacturing 34, 316-327 (2019), but incorporation of laser ablation of polymers into methods and apparatus as described herein is neither suggested nor disclosed.

Also provided are methods of making a three-dimensional object by additive manufacturing that includes the steps of (a) forming a three-dimensional object on a build platform; (b) positioning a resin coated film under the three-dimensional object, wherein the resin coated film may contact the three-dimensional object or a void space may be present between the resin coated film and the three-dimensional object; (c) exposing a portion of the resin coated film to laser radiation (e.g., UV, visible, or IR laser light using a secondary light source) sufficient to eject at least a portion of the resin onto a bottom surface of the three-dimensional object; (d) exposing the ejected resin on the bottom surface of the three-dimensional object with actinic radiation or light using the additive light source to polymerize the ejected resin; and (e) sequentially repeating steps (b) through (d). The ejection of the resin may be achieved using a number of methods including a direct jetting method or a blister transfer method.

The foregoing and other objects and aspects of the present invention are explained in greater detail in the drawings herein and the specification set forth below. The disclosures of all United States patent references cited herein are to be incorporated herein by reference.

### BRIEF DESCRIPTION OF THE DRAWINGS

FIG. 1A schematically illustrates a prior art method and apparatus, in which a new build segment is being exposed to patterned light.

FIG. 1B schematically illustrates the prior art method and apparatus of FIG. 1A, in which the new build segment has been polymerized and advanced away from the resin applicator film.

FIG. 2A schematically illustrates a method and apparatus as described herein, in which a new build segment is being exposed to patterned light.

FIG. 2B schematically illustrates a method and apparatus of FIG. 2A, in which the new build segment has been polymerized and advanced away from the resin applicator film.

FIG. 2C schematically illustrates a method and apparatus of FIGS. 2A-2B, in which excess material on the edge portions of the new build segment is being removed by laser light from the second (laser) light source.

FIG. 2D schematically illustrates a method and apparatus of FIGS. 2A-2B, in which excess material on the edge portions of the new build segment is being removed by laser light from the second (laser) light source.

FIG. 2E schematically illustrates a method and apparatus of FIGS. 2A-2B, in which excess material on the edge portions of the new build segment is being removed by laser light from the second (laser) light source.

FIG. 2F schematically illustrates a method and apparatus of FIGS. 2A-2E, in which the build surface of the new build segment is being treated by the second, laser, light source.

FIG. 2G schematically illustrates a method and apparatus of FIGS. 2A-2E, in which the build surface of the new build segment is being treated by the second, laser, light source.

FIG. 2H schematically illustrates a method and apparatus of FIGS. 2A-2G, now ready for exposure of a new build segment to patterned light (i.e., a repeating of the step shown in FIG. 2A).

FIG. 3 schematically illustrates an alternative embodiment of a method and apparatus as described herein, in which the second, laser, light source is positioned so it need not project through the film resin applicator.

FIG. 4A schematically illustrates an additional alternate embodiment of the method and apparatus described herein, in which the film applicator travels across the build surface of the growing three-dimensional object, by lateral movement of the carrier platform (dashed arrow), lateral movement of the film applicator carrier assembly (dashed arrow), or both.

FIG. 4B shows the embodiment of FIG. 4A, with excess material on the leading edge of the new build segment being removed by laser light from the second light source.

FIG. 4C shows the embodiment of FIGS. 4A-4B, with the build surface of the new build segment being treated by the second, laser, light source.

FIG. 4D shows the embodiment of FIGS. 4A-4C, with excess material on the trailing edge of the growing three-dimensional object being removed by laser light from the second light source.

FIG. 5A schematically illustrates an alternative embodiment of the invention in which an apparatus is configured to eject resin from a a resin coated film onto a three-dimensional object using laser light.

FIG. 5B schematically illustrates the embodiment of FIG. 5A after the laser light has been ejected onto the three-dimensional object.

### DETAILED DESCRIPTION OF ILLUSTRATIVE EMBODIMENTS

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

As used herein, the term “and/or” includes any and all possible combinations of one or more of the associated listed items, as well as the lack of combinations when interpreted in the alternative (“or”).

### 1. Additive Manufacturing Resins and Apparatus.

Resins. Any suitable resin that includes a monomer and/or prepolymer component that is cured by actinic radiation or light, particularly UV light, may be used to carry out the present invention. Examples include but are not limited to those set forth in U.S. Pat. Nos. 9,360,757 and 9,211,678 to DeSimone et al. In some embodiments, the resin comprises a dual cure resin, including but not limited to those set forth in U.S. Pat. Nos. 9,676,963 and 9,598,606 to Rolland et al.

In some embodiments, the resin comprises a high viscosity resin. For example, in some embodiments, the resin has a viscosity of 1,000 or 2,000, 10,000, 20,000 centipoise or more, up to 100,000, or 200,000 centipoise or more, at 25 degrees Centigrade and 1 atmosphere pressure (i.e., “standard conditions”). In some embodiments, the resin has a viscosity of from 100,000 centipoise to 1,000,000 or 2,000,000 centipoise or more, at 25 degrees Centigrade and 1 atmosphere pressure.

In some embodiments, the resin contains a substantial amount of filler (e.g., at least 10, 20, 30, or 40 percent by volume of filler, up to 80 percent by volume of filler). Suitable fillers include but are not limited to solid fiber fillers, spherical fillers, elliptical fillers, etc. In some embodiments the filler is a solid particulate filler, including but not limited to glass fiber, carbon fiber, aramid fiber, basalt fiber fillers, thermoplastic and thermoset polymer fibers (e.g., polyamide, cellulose, or nanocellulose, fibers, etc.). See, e.g., V. Dhand et al., A short review on basalt fiber reinforced polymer composites, Composites Part B: Engineering 73, 166-180 (2015); A. Dufresne, Nanocellulose: a new ageless bionanomaterial, Materials Today 16, 220-227 (June 2013). In some embodiments, the filler comprises a porogen or microballoon filler, such as described in U.S. Pat. No. 11,292,186 to Poelma.

Applicator apparatus with additive light source. The methods described herein can be carried out with a variety of additive manufacturing apparatus as the base apparatus, further modified to include a second, subtractive or ablative, light source and additional features as described herein. Examples of suitable base apparatus include, but are not limited to, those in which the resin is applied to a movable, light transmissive, film, and from that film to a build surface of the growing 3D object, to bring sequential slices of resin into a “build zone” and thereby form a new build segment. The film may in some embodiments be a semipermeable film that is permeable to oxygen. Patterned light is then projected into the build segment (in some embodiments through the film) from a first light source (i.e., the additive light source), in a bottom-up or top-down fashion, to polymerize those build segments, again in a sequential manner, and form the 3D object. Examples of such apparatus are disclosed in U.S. patent Ser. No. 10/792,868 (Carbon, Inc.); U.S. Pat. No. 9,862,146 (DSM); U.S. Pat. No. 8,905,739 (TNO); U.S. Pat. No. 5,650,260 (Teijin); and U.S. Pat. No. 5,637,169 (3D Systems); and in PCT Publication No. WO2021/180997 (BCN3D). In some embodiments, the apparatus can be one in which a roller, rather than a light transmissive film, applies the resin to the build platform or growing 3D object, as shown in U.S. Pat. No. 11,192,302 (Carbon, Inc.) The disclosures of all of these references are incorporated by reference herein in their entirety.

Subtractive (ablative) light source. Suitable subtractive, or ablative, light sources for use in combination with apparatus as described above include, but are not limited to, laser light sources, ultraviolet (UV) light sources, vacuum UV light sources, deep UV light sources, and high intensity infra-red (IR) light sources, including combinations thereof.

Examples of suitable laser subtractive light sources include, but are not limited to, a gas laser (e.g., a CO₂ laser, a helium-neon laser, an argon laser, a krypton laser, or an excimer laser)), a solid-state laser (e.g., a ruby laser, an Nd: YAG laser), a fiber laser (e.g., a ytterbium or erbium-doped fiber laser), a liquid laser (also known as a dye laser, and including tunable lasers), or a semiconductor laser (e.g., diode lasers, quantum cascade lasers, optically pumped semiconductor lasers, etc.). Particular examples include CO₂ lasers; excimer lasers such as KrF 248 nm, ArF 193 nm, XeCl or XeF; and YAG lasers such as 355 nm frequency tripled YAG and 266 nm frequency quadrupled YAG.

The laser light source may comprise a continuous wave light source or a pulsed laser light source. In some embodiments a short pulse laser, including nanosecond, picosecond and femtosecond pulse lasers, are preferred for their reducing of the heat affected zone (HAZ). The laser light source may be a single beam light source or a multi-beam light source, may be a free-standing laser or a fiber-optic based laser; may comprise a single wavelength light source or a multi-wavelength light source; etc. The laser light source may be selected, based upon the resins for which it is to be applied, so that the resin absorbs single or multiple photons, e.g., to control speed, resolution, and/or HAZ.

The laser light source may take any of a variety of configurations and may include any of a variety of features known in the art. For example, the laser light source may comprise a laser trepanning system and apparatus. It may include an XY stage for scanning or raster scanning of the laser beam; a beam expander, mirror, focusing lens, and/or air assist; it may include a Z focusing component such as a motorized focusing mechanism; it may include additional optical elements such as fiber optics, diffraction optical elements and beam splitters; elements for focusing the laser beam including but not limited to f-theta lenses and motor driven z-focusing components, laser beam shaping components such as refractive beam shaping elements, diffractive beam shaping elements, laser beam integrators, axicons for generating Bessel beams, cylinder lenses and anamorphic prism pairs for circularizing beams, etc. The light source may include combinations of the foregoing elements as is known in the art.

Suitable laser light sources, and/or components thereof which may be included in subtractive light sources described herein, are further described in U.S. Pat. No. 6,864,459 (Lawrence Livermore); U.S. Pat. No. 8,673,745 (Hamamatsu Photonics; multiphoton absorption) U.S. Pat. No. 9,701,564 (Corning); U.S. patent Ser. No. 10/058,953 (Trumpf); U.S. patent Ser. No. 10/300,555 (Trumpf); U.S. patent Ser. No. 10/312,659 (Coherent); U.S. patent Ser. No. 10/343,237 (IPG Photonics); U.S. patent Ser. No. 10/444,597 (Coherent); U.S. patent Ser. No. 11/014,194 (Coherent); U.S. patent Ser. No. 11/364,572 (IPG Photonics) Ser. No. 11,534,858 (IPG Photonics); U.S. patent Ser. No. 11/548,093 (Coherent); and in U.S. Patent Application Publication Nos. US2022/0390713 (Trumpf, optical arrangement with an f-theta lens); and US2022/0360036 (Trumpf), the disclosures of all of which are incorporated by reference herein in their entirety as if fully set forth. See also S. Ravi-Kumar et al., Laser Ablation of Polymers: A Review, Procedia Manufacturing 34, 316-327 (2019),

In addition to the foregoing, suitable subtractive laser light sources and/or components thereof are commercially available from COHERENT, INC., 5100 Patrick Henry Drive, Santa Clara, CA 95054 USA, IPG PHOTONICS, 50 Old Webster Road, Oxford, MA 01540 USA, TRUMPF SE+Co. KG, Johann-Maus-Strasse 2, 71254 Ditzingen, Germany, AMPLITUDE LASER GROUP, Cite de la Photonique, 11 Ave. de Canteranne, 33600, Pessac, France, LASERAX USA, 2401 Parkman Rd. NW, Warren, OH 44485 USA, and others.

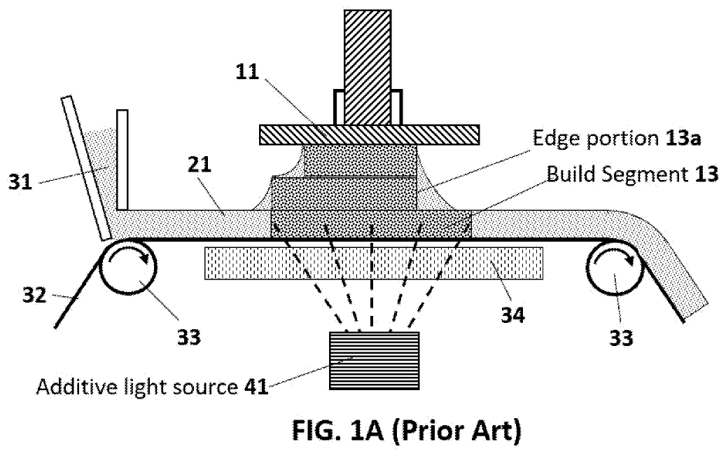

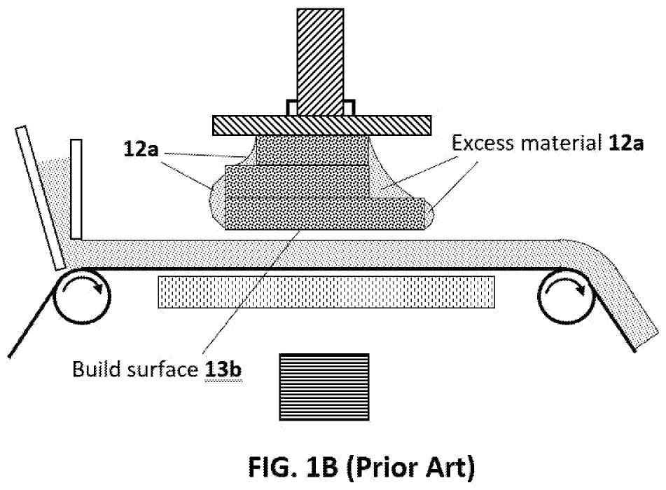

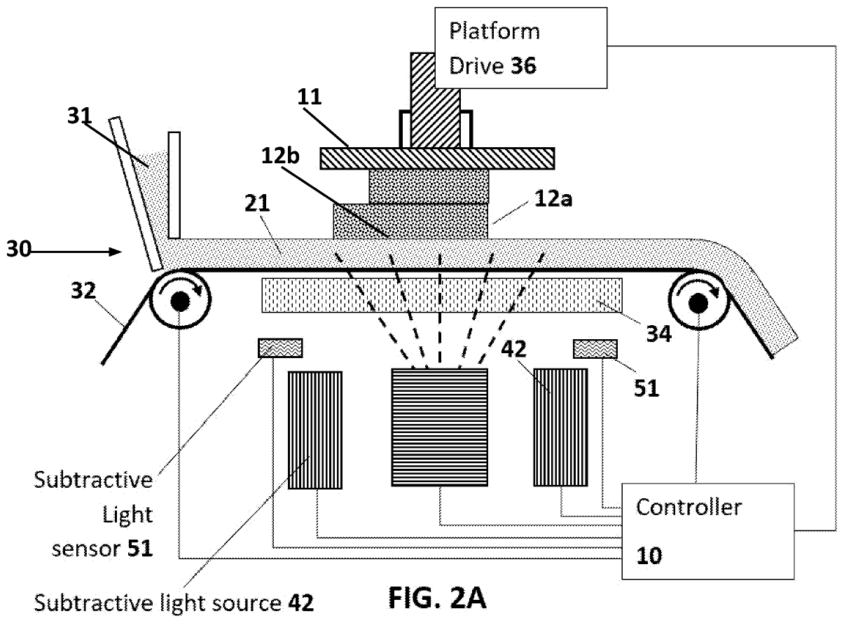

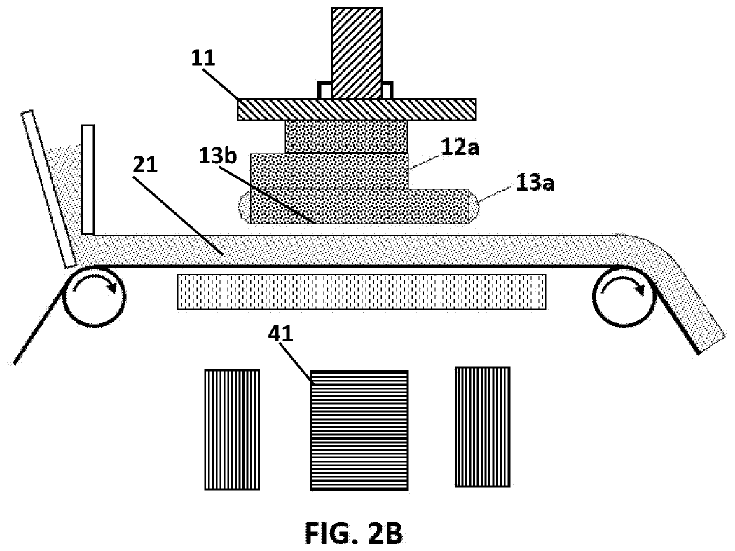

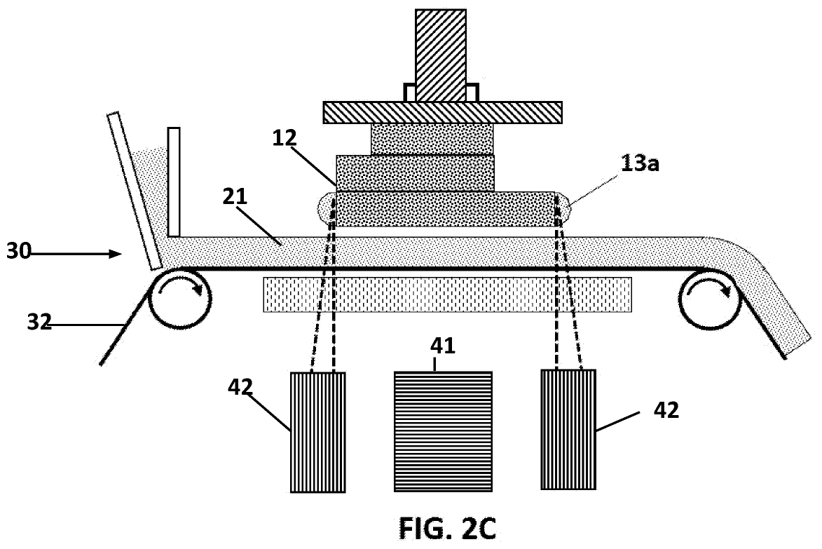

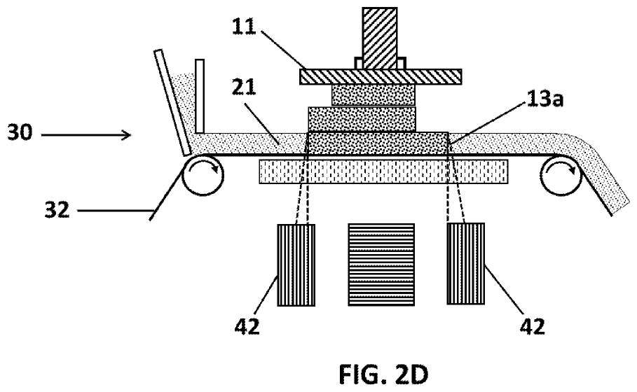

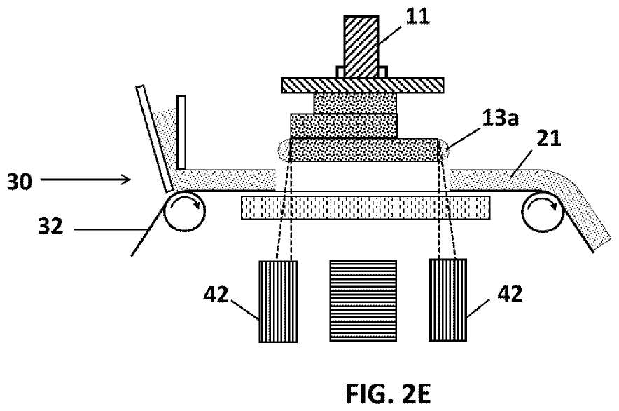

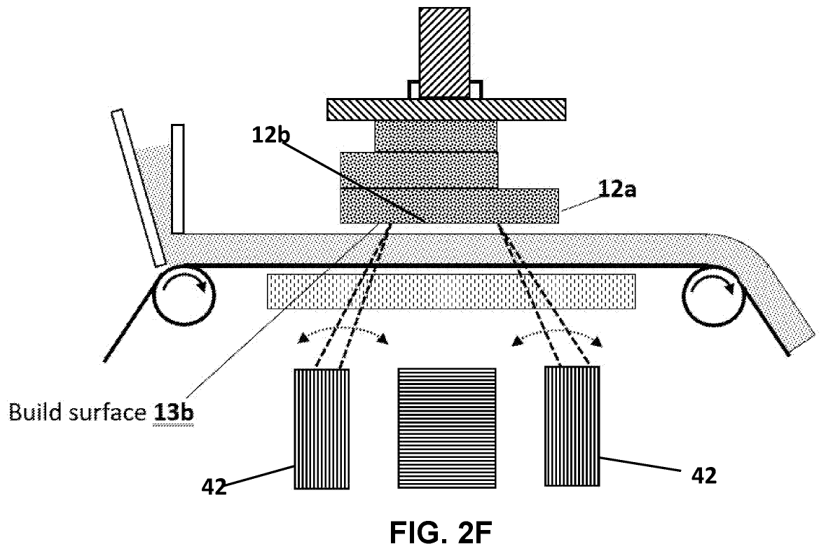

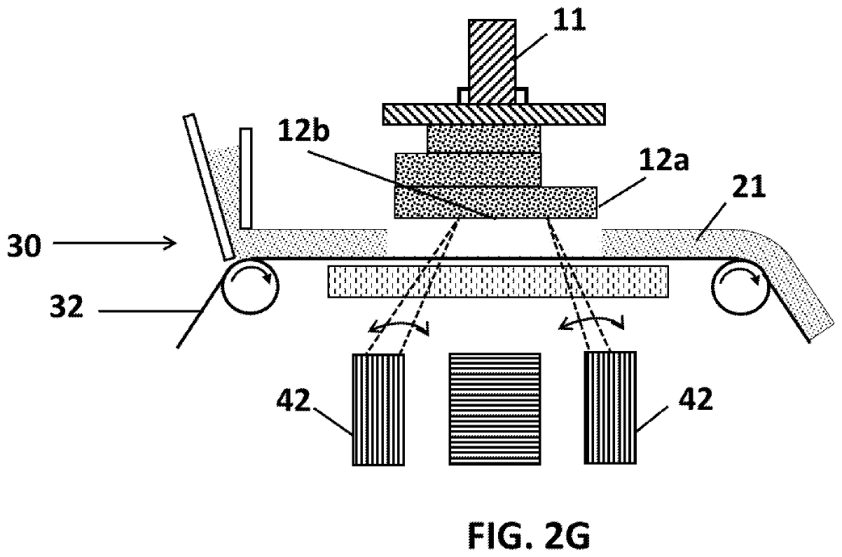

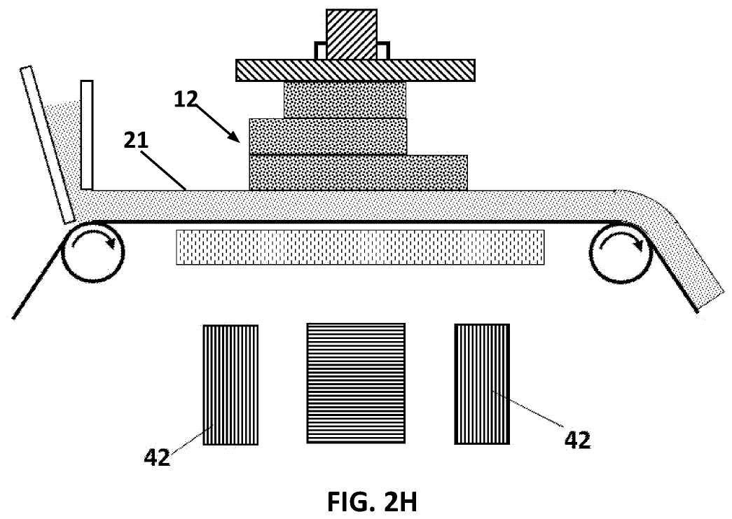

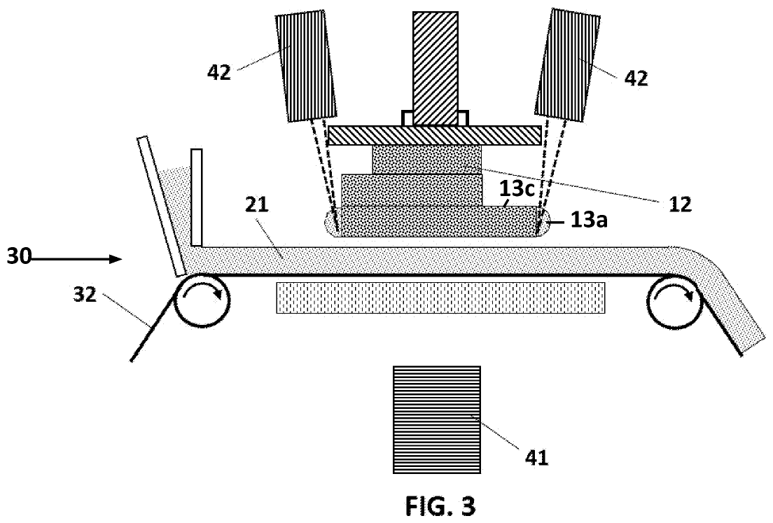

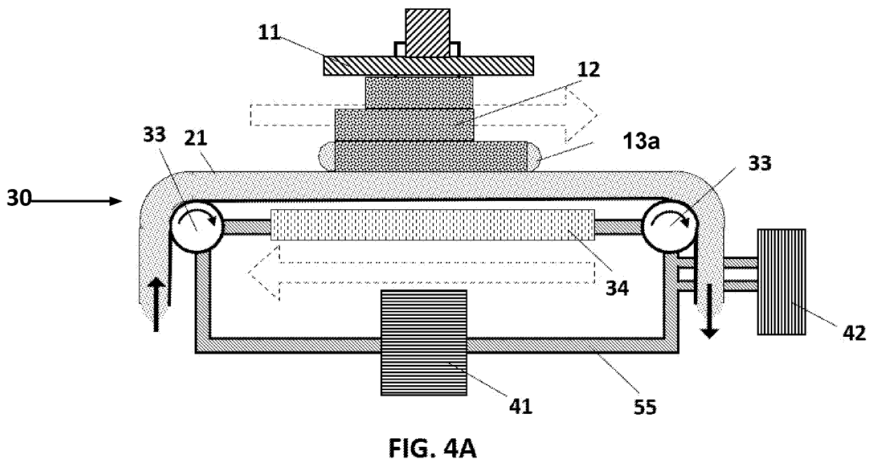

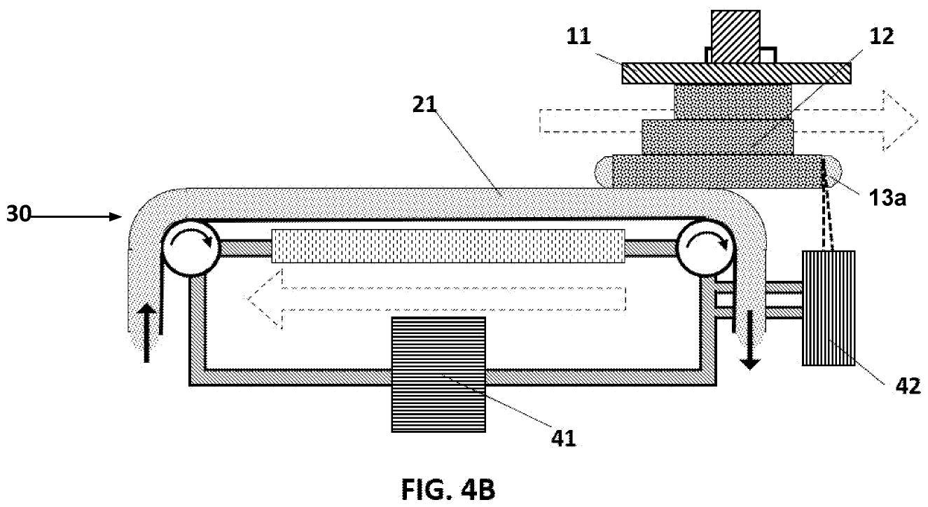

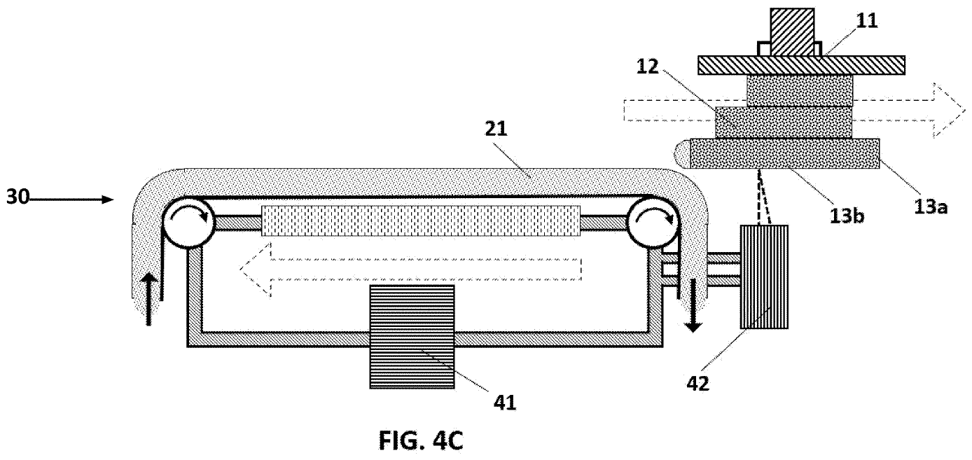

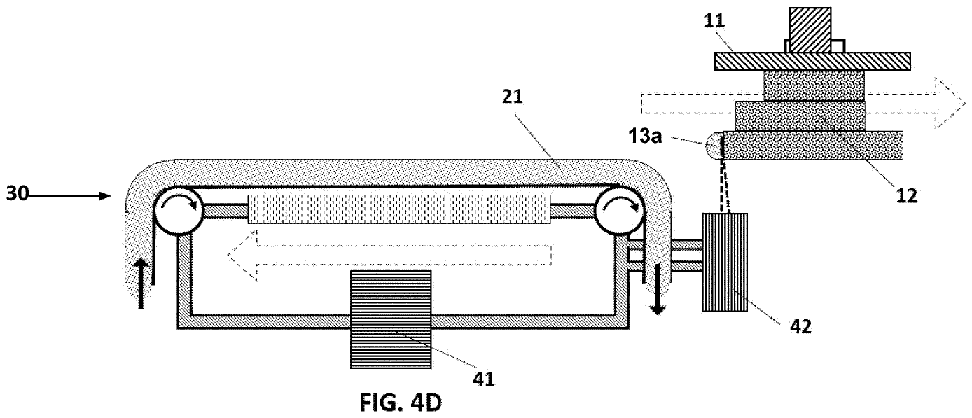

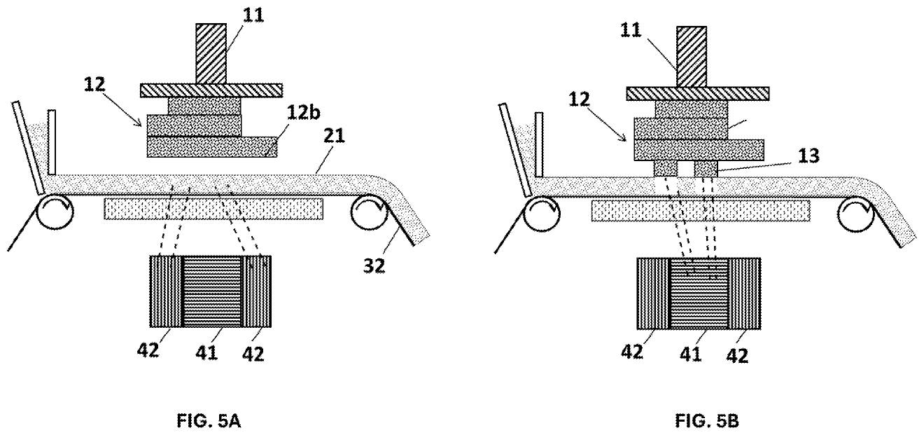

Apparatus with combined and coordinated additive and subtractive light sources. As an introduction, FIGS. 1A-1B illustrate a prior art apparatus, aspects of which may be included in an apparatus of the invention. A first embodiment of an apparatus of the invention is given in FIGS. 2A-2E, the sequence of which illustrates an embodiment of a method as described herein. A Second embodiment of an apparatus is given in FIG. 3, and a third embodiment of an apparatus is given in FIGS. 4A-4D, the sequence of which again illustrates an embodiment of a method as described herein. A fourth embodiment of an apparatus is given in FIGS. 5A-5B, the sequence of which illustrates an embodiment of a method as described herein. Like numbering is applied to common features throughout these figures. Note that in these figures the apparatus is shown in a “bottom-up” configuration, but the orientation of these apparatus can be reversed or “flipped” to a “top-down” orientation.

In overview, an apparatus for additively manufacturing a three-dimensional object from a light polymerizable resin as described herein can include:
(a) a build platform 11 on which a growing three-dimensional object 12 can be produced, the object having a build segment 13, the build segment including an edge portion 13a and a build surface 13b;
(b) an applicator 30 as discussed below, the applicator configured for applying a light-polymerizable resin 21 to the build surface to form a new build segment including an edge portion and a build surface, wherein said applicator comprises a moving roller or moving film resin applicator;
(c) a resin supply 31 configured for applying light polymerizable resin to said applicator;
(d) a first, additive light source 41 configured for polymerizing resin in said build segment; and
(e) a second, subtractive light source 42 configured for delivering a dosage of light to the edge portion(s) and/or the build surface(s).

Excess material or residual resin 12a is illustrated as adhered to edge portions 13a in various ones of the Figures, and is discussed further in connection with methods, below.

In some embodiments, the applicator comprises a moving roller resin applicator (not shown), such as described in U.S. Pat. No. 11,192,302 (Carbon, Inc.), the disclosure of which is incorporated herein by reference in its entirety.

In other embodiments, such as shown in FIGS. 2A-4D, the applicator comprises a moving film resin applicator. Examples of such applicators are disclosed in U.S. Pat. Nos. 10,792,868 (Carbon, Inc.); 9,862,146 (DSM); U.S. Pat. No. 8,905,739 (TNO); U.S. Pat. No. 5,650,260 (Teijin); 5,637,169 (3D Systems); and PCT Publication No. WO2021/180997 (BCN3D). In some embodiments, the moving film is light-transmissive and the first light source projects through said moving film. Elements may be physically connected to one another directly or indirectly through a common support or chassis 55. In some embodiments, the second, subtractive, light source projects through the moving film (as shown, for example, in FIGS. 2A-2H), while in other embodiments, the second, subtractive, light source does not project through said moving film (e.g., by positioning on the opposite side of said moving film from said first light source, or by positioning adjacent the moving film where the moving film is not between the carrier platform and/or growing object), as shown for example in FIG. 3 and FIGS. 4A-4D. Such applicators may in some embodiments include a moving film drive assembly such as rollers 33 for advancing the moving film, a rigid optically transparent backing 34 for supporting the moving film, a supporting frame 35 (not shown in some embodiments), a platform drive 36 operatively associated with the carrier platform. Some components are not shown in some Figures for purpose of clarity (for example, the controller 10 is only shown in FIG. 2A, and the resin supply 31 is not shown in FIGS. 4A-4D but will be apparent from the patents incorporated by reference above).

A controller 10 can be operatively associated with the first and second light sources 41, 42, the moving film drive assembly (or the moving roller drive), and the platform drive 36, with the controller configured (in hardware and/or software) to carry out a method as described hereinbelow.

In some embodiments, the laser source further comprises a sensing system for metrology (e.g., to maintain beam quality) As schematically illustrated in FIG. 2A, such a sensing system may include a detector 51 configured for insertion in and out of the beam path (by movement of the beam or movement of the detector) or employ an integrated beam splitter that generates a dedicated beam for the sensor. The sensor (including a plurality of sensors) can detect beam focus, wavelength, intensity, or a combination thereof. The sensor may be operatively associated with the controller 10, which controller is operably associated with the subtractive light source 42 as noted above, to provide a feedback system for adjusting the focus, wavelength, and/or intensity of the laser light when a deviation from desired or pre-set parameters is detected.

While not shown, the apparatus may include a system for managing the gases, particles, or the like created by the subtractive process. Such a system is implemented in accordance with known techniques and can include a work chamber enclosing the apparatus, an inert gas (e.g., nitrogen, argon) supply for flushing the chamber (or relevant work area) during the process, and/or a wash liquid (e.g., aqueous liquid) supply for flushing the relevant work area during the process, a vent and/or a drain, sensors for detecting levels of gases and/or particles generated by the subtractive process with associated controllers, etc.

Methods. A variety of methods can be implemented with the apparatus described above. Such methods are described further below, and can be implemented independently of one another or in combination with one another, as also described further below.

A first method of making a three-dimensional object by additive manufacturing described herein includes the steps of:
(a) applying a light polymerizable resin to a build surface of a growing three-dimensional object to form a build segment, said applying carried out with a moving roller resin applicator or a moving film resin applicator;
(b) exposing said build segment to patterned light to polymerize said build segment and form a new build surface, said new build surface having edge portions, said edge portions carrying excess, polymerized or unpolymerized, material thereon;
(c) exposing said excess material to an ablation light (e.g., laser light) at a dosage (i.e., an exposure pattern, wavelength, intensity and duration) sufficient to remove said excess material from said edge portions (e.g., by ablation or melting); and
(d) sequentially repeating steps (a) through (c), with step (c) optionally omitted during some of said sequentially repeating steps but included during at least a plurality of said sequentially repeating steps, until said three-dimensional object is formed.

Such a method is schematically illustrated in the sequence of steps schematically illustrated in FIGS. 2A-2E, in FIG. 3, and in FIGS. 4A, 4B & 4D. Note that, in executing the method shown in FIGS. 2A-2D, the laser will in some embodiments remove resin on the carrier film, in addition to that on the part. This feature is omitted from the Figures for clarity. Note also that laser penetration depth can be controlled in accordance with known techniques by choosing the combination of laser wavelength and absorption values of additives and resin components at the laser wavelength. The resin components may have innate absorption at the laser wavelength. If not, dyes or pigments can be chosen to achieve a desired value. The particular value for the penetration dept is motivated having a value much below the expected resin thickness (about 10's of um's) and maximize the energy density, to avoid transmission of radiation. The depth of penetration is chosen to optimize or effect the mode and behavior of the resin that is removed from the surface.

A second method of making a three-dimensional object by additive manufacturing described herein includes the steps of:
(a) applying a light polymerizable resin to a build surface of a growing three-dimensional object to form a build segment, and with said applying carried out with a moving roller resin applicator or a moving film resin applicator;
(b) exposing said build segment to patterned light to polymerize said build segment and form a new build surface,
(c) exposing said new build surface to an ablation light (e.g., laser light) to physically and/or chemically modify said new build surface; and
(d) sequentially repeating steps (a) through (c), with step (c) optionally omitted during some of said sequentially repeating steps but included during at least a plurality of said sequentially repeating steps, until said three-dimensional object is formed.
   Such a method is schematically illustrated in FIGS. 2F-2G and FIG. 4C. Note that this second method can be practiced independently of the first method described above, or in combination with that method, as schematically illustrated in FIGS. 2A-2H and FIG. 4A-4D.

In some embodiments of the second method, the exposing step (c) is carried out at a dosage (i.e., an exposure pattern, wavelength, intensity and duration) that textures at least a portion (e.g., a major portion) of said new build surface (e.g., the pattern configured to enhance adhesion of a subsequent build segment to said new build surface).

In some embodiments of the second method, the light polymerizable resin comprises an additive (e.g., a thermoplastic material such as nylon powder, a natural or synthetic rubber, ceramic particles, etc.), and said exposing step (c) is carried out at a dosage (i.e., an exposure pattern, wavelength, intensity and duration) that selectively melts or sinters said additive (e.g., to form a co-continuous secondary material network) in at least a portion (e.g., a major portion) of said new build surface and modify the material properties of the three-dimensional object (e.g., such as increase toughness, and/or promoting interlayer adhesion, strength or toughness).

In some embodiments of the second method, the light polymerizable resin is a dual cure resin comprising a first polymerizable component and a second polymerizable component and said exposing step (c) is carried out at a dosage (i.e., an exposure pattern, wavelength, intensity and duration) that initiates polymerization of said second polymerizable component in at least a portion (e.g., a major portion) of said new build surface to modify the mechanical properties of said three-dimensional object (e.g., in the green and/or final steps) (in some embodiments theses exposure dosages may be patterned, spatially and/or temporally, to create control of and modify the spatial distribution of material properties in the three-dimensional object).

In some embodiments of the second method, the exposing step (c) is carried out at a dosage (i.e., an exposure pattern, wavelength, intensity and duration) that modifies material properties (e.g., modifies glass transition temperature) in at least a portion (e.g., a major portion) of said new build surface (e.g., to modify internal stresses in the object and thereby modify final object geometry).

In some embodiments of the second method, the exposing step (c) is carried out at a dosage (i.e., an exposure pattern, wavelength, intensity and duration) that activates surface chemicals (e.g., modifies glass transition temperature) in at least a portion (e.g., a major portion) of said new build surface (e.g., to promote adhesion, modify the surface energy, and/or control the wettability of the resin.

In some embodiments of the second method, the light polymerizable resin comprises a filler (e.g., a porogen or microballoon), and said exposing step (c) is carried out at a dosage (i.e., an exposure pattern, wavelength, intensity and duration) that selectively expands said filler (e.g., to thereby counteract shrinkage and/or warpage of said object) in at least a portion (e.g., a major portion) of said new build surface.

In some embodiments of all of the foregoing methods, the applying step is carried out with a bottom-up or top-down additive manufacturing apparatus, with a moving roller resin applicator, and/or with a moving film resin applicator (e.g., where the moving film is a light-transmissive film, through which the patterned light, and optionally the ablation light, is projected).

A third method of making a three-dimensional object by additive manufacturing described herein includes the steps of:
(a) forming a three-dimensional object on a build platform;
(b) positioning a resin coated film under the three-dimensional object, wherein the resin coated film may contact the three-dimensional object or a void space may be present between the resin coated film and the three-dimensional object;
(c) exposing a portion of the resin coated film to laser radiation (e.g., UV, visible, or IR laser light using a secondary light source) sufficient to eject at least a portion of the resin onto a bottom surface of the three-dimensional object;
(d) exposing the ejected resin on the bottom surface of the three-dimensional object with actinic radiation or light using the additive light source to polymerize the ejected resin; and
(e) sequentially repeating steps (b) through (d).

In some embodiments of all of the foregoing methods, the laser light is at a dosage which is absorbed by said excess material and/or said new build surface in single photon or multiphoton absorption process; the laser light is delivered to said excess material and/or said new build surface as a shaped beam; and/or the laser light is delivered to said excess material and/or said new build surface as a continuous wave or pulsed laser beam.

In some embodiments of all of the foregoing methods, the method can further include the steps of detecting a current property (e.g., focal field, focal length, wavelength, intensity) of said ablation light; comparing said current property to a desired property (e.g., focal field, focal length, wavelength, intensity) and modifying said ablation light so that said current property more closely corresponds to said desired property.

Examples of apparatus and methods of the invention will now be more particularly described. Referring to FIG. 2A, an apparatus of the invention may include a build platform 11 on which growing three-dimensional object 12 with edge 12a and build surface 12b is being fabricated. The moving film resin applicator 30 which includes resin supply 31, film 32, rollers 33, and rigid optically transparent backing 34, moves the resin 21 to the appropriate position and the three-dimensional object 12 contacts the resin 21. The additive light source 41 emits light or actinic radiation through the optically transparent backing 34 and film 32 to polymerize the light polymerizable resin 21. In this embodiment, subtractive light sources 42 and subtractive light sensors 51 are positioned below the applicator 30 and below the film 32. In addition, in this embodiment, a controller 10 is configured to operate the various components of the apparatus including but not limited to the platform drive 36, which may move the platform 11 vertically and/or horizontally, the additive light source 41, and/or the subtractive light source 42. Controller 10 may operate similarly with any of the other apparatus and methods described herein.

Referring to FIG. 2B, the light or actinic radiation from the additive light source 41 may interact with the light polymerizable resin 21 to solidify the resin 21, thus creating a solid build segment 13 having edge portion 13a and build surface 13b attached to the three-dimensional object 12. As shown in FIG. 2B, the edges 13a of build segment 13 have excess material (either excess resin or excess partially or fully cured polymer) thereon.

Referring to FIG. 2C-2E, in some embodiments, the subtractive light source 42 (e.g., laser) is below the three-dimensional object 12, applicator 30, and resin 21 coated film 32. In FIG. 2C, the subtractive light source 42 delivers a dosage of light through the resin 21 and film 32 to ablate the excess material on edges 13a of the build segment 13. In some embodiments, a portion of the resin 21 on the film 32 is also ablated as the dosage of light passes therethrough. In FIG. 2D, the subtractive light source 42 delivers a dosage of light through resin 21 and film 32 to ablate the excess material on edges 13a while the build segment 13 is on the film 32. In FIG. 2E, the subtractive light source 42 delivers a dosage of light through the film 32 to ablate the excess material on edges 13a of the build segment 13 but not through resin 21. For example, the subtractive light source 42 may deliver the dosage after the additive light source 41 solidifies the build segment 13 to the three-dimensional object and the build platform lifts the build segment 13 off the film 32 but before new resin 21 is positioned under the three-dimensional object 12.

FIGS. 2F-2G schematically illustrate the three-dimensional object 12 after ablation of excess material. In certain embodiments, the subtractive light source 42 may emit ablation light (e.g., laser light) to physically and/or chemically modify the build surface 12b. For example, the build surface 12b may be modified to promote adhesion of the build surface 12b to a subsequent layer, either by altering or removing a portion of the solid polymer at the build surface 12b (e.g., texturing the surface) or by modifying a filler in the polymer (e.g., melting or sintering glass or fillers, activating reactive fillers, etc.). In another embodiment, a portion of the solid polymer at the build surface 12b is removed while leaving any filler unmodified. Additionally, in other embodiments, the ablation light may be used to improve toughness and/or reduce anisotropy at the build surface 12b. In FIG. 2F, the subtractive light source 42 delivers a dosage of light through resin 21 and film 32 to physically and/or chemically modify the build surface 12b, whereby some of the resin 21 on the film 32 may also be removed and/or modified. In FIG. 2G, the subtractive light source 42 delivers a dosage of light through the film 32 to physically and/or chemically modify the build surface 12b but not through resin 21. For example, the subtractive light source 42 may deliver the dosage after the additive light source 41 solidifies the build segment 13 to the three-dimensional object and the build platform lifts it off the film 32 but before new resin 21 is positioned under the three-dimensional object 12.

FIG. 2H shows the larger three-dimensional object 12 directly after the ablation of excess material shown in FIGS. 2C-2E and/or after modifying the build surface as shown in FIGS. 2F-2G. In addition, in some embodiments, the ablation of the excess material in FIG. 2C-2E is not needed and the subtractive light source 42 is only used to modify the build surface as shown in FIG. 2D. In FIG. 2H, the three-dimensional object 12 may then contact additional resin 21 to repeat the process and continue to grow the three-dimensional object 12.

FIG. 3 illustrates an alternative configuration of the subtractive light source(s) 42 that may be used in some embodiments. In this configuration, the subtractive light sources 42 are positioned above the three-dimensional object 12, applicator 30, and resin 21 on film 32, and optionally above the build platform 11. In such cases, the excess material on the edges 13a of the build segment 13 may be ablated from above the object 12. In this configuration, the subtractive light sources 42 may not be able to modify build surface 13b. However, the subtractive light source 42 may modify or ablate upward facing surfaces (e.g., upper surface 13c of build segment 13). In some embodiments, subtractive light source(s) 42 may be present both below and above the three-dimensional object 12, applicator 30, and resin 21 on film 32.

Referring to FIGS. 4A-4D, in some embodiments, the build platform 11 and/or the film applicator 30 may be translated in the lateral direction during the printing process. For example, in FIG. 4A, the film applicator 30 translates across the growing three-dimensional object 12 via lateral movement of the carrier platform 11 (see dashed arrow), lateral movement of the film applicator 30, or both, with the subtractive light source(s) 42 positioned to the side of the film applicator 30. The lateral movement may also be used in embodiments with the subtractive/laser light source 42 at another position, including under the film 32 and three-dimensional object 12 or above the applicator 30 and/or build platform 11.

FIG. 4B shows the embodiment of FIG. 4A after the build platform 11 and/or the film applicator 30 is translated in the lateral direction. The build platform 11 and three-dimensional object 12 are translated past the edge of the film applicator 30. The excess material on the leading edge 12a of the new build segment 12 may be removed by ablative laser radiation from the second light source 42. FIG. 4C shows the embodiment of FIGS. 4A-4B further translated laterally so that the ablative light source 42 may irradiate the build surface 13b of the new build segment 13 by the second, laser, light source and without passing through resin 21. FIG. 4D shows the embodiment of FIGS. 4A-4C, with excess material on the trailing edge of the growing three-dimensional object being removed by laser light from the second ablative light source 42.

The methods of the invention may allow for an object to be fabricated without the need for additional washing and/or sanding/polishing as excess resin, including excess resin at part borders and edge menisci, may be removed by laser ablation, either in-situ (see, e.g., FIGS. 2A-2E) or ex-situ (see, e.g., FIG. 3 or FIGS. 4A, 4B, and 4D).

In the methods of the invention, the penetration depth of the laser may be varied based on, e.g., the field angle of the laser and the structure of the three-dimensional object. For example, if there is an underlying or adjacent structure to the excess material, a relatively short penetration depth may be warranted. However, if the laser is directed in a manner so that it would avoid cured areas or if the transmitted beam energy is sufficiently low to avoid unintended part damage, longer penetration depths may be warranted.

In some embodiments, shadowing effects may be reduced or eliminated by using a low field angle, either with a full field lens to cover the build area or using a sub-build field size and a scanning stage to cover the build area. In some embodiments, shadowing may be reduced by using a higher field angle but using a scanning system and complex patterning to achieve desirable results. In some cases, a multi-module scanning laser system may be used, and lasers may be positioned below, above, and/or to the side of the film applicator and build platform.

In some embodiments, removal of excess resin is achieved by using narrow laser-UV alignment tolerances between the part border and laser scanning system. The addition of a machine vision feature (e.g., camera) may facilitate alignment of laser with part boundaries, and so such a feature may be included in apparatus of the invention.

In some embodiments, laser ablation may be used to remove protruding fibers from a part surface. If the fibers are glass fibers, in some cases, CO₂ or DUV lasers may achieve the best results. The use of such techniques may allow for the use of longer glass fibers in certain objects, which may provide desirable properties in the final three-dimensional object.

In some embodiments, the use of laser ablation may provide more accurate or precise build surfaces than can be achieved by a UV curing system alone or may allow for the use of an additive light system having less precision. In this case, cured resin may be ablated and this may require higher pulse energies.

Referring to FIGS. 5A-5B, a third method of making a three-dimensional object by additive manufacturing includes the steps of (a) forming a three-dimensional object 12 on a build platform 11; (b) positioning a resin 21 coated film 32 under the three-dimensional object 12, wherein the resin 21 coated film 32 may contact the three-dimensional object 12 or a void space may be present between the resin coated film 32 and the three-dimensional object 12; (c) exposing a portion of the resin 21 coated film 32 to laser radiation (e.g., UV, visible, or IR laser light using secondary light source 42) sufficient to eject at least a portion of the resin 21 onto a bottom surface 12b of the three-dimensional object 12; (d) exposing the ejected resin 21a on the bottom surface 12b of the three-dimensional object 12 with actinic radiation or light using the additive light source 41 to polymerize the ejected resin; and (e) sequentially repeating steps (b) through (d). In some cases, the laser radiation in step (c) is patterned laser radiation and creates a pattern of ejected resin. However, in some embodiments, the additive light source 41 that cures the ejected resin is patterned. Both light sources may use patterned light in some embodiments.

In some embodiments, the ejected resin 21a is transferred to the three-dimensional object 12 using a direct jetting ejection, whereby laser pulses vaporize the resin 21 to transfer to the bottom surface 12b of the three-dimensional object 12. In other embodiments, a “blister transfer” method is used whereby laser pulses focused through the film 32 may create blisters (not shown) whose emergence creates the transfer impulse for the ejection of resin 21.

Additively manufactured objects. A variety of different three-dimensional objects can be produced by the methods described above. The objects may be rigid, flexible, or elastic, depending upon the choice of resin. The objects may include three-dimensional lattices, including strut lattices, surface lattices, and combinations thereof. The objects can be electrical, mechanical, or fluid connectors, cushions such as helmet liners, midsoles, body pads, bedding or seat cushions, etc. aerospace or automotive body panels, ductwork, or the like, housings for mechanical or electrical components, etc.

Non-limiting examples of particular embodiments and use-cases for the methods and apparatus described herein are given in Table 1 below.

TABLE 1
USE CASES FOR ADDITIONAL LASER PROCESSING WITH MOVING FILM AND MOVING ROLLER RESIN APPLICATORS.

| | | PREFERRED | |
|---|---|---|---|
| | | APPARATUS | |
| OBJECT | PURPOSE | CONFIGURATION | NOTES AND COMMENTS |
| Enable | Removal of excess resin | In-situ (through film); | Short penetration depth preferred, but tolerant of longer penetration |
| washless | overcoating at part borders | Ex-situ (e.g., FIG. 4) | depths if scanning configured to avoid going over cured part regions, |
| printing | including edge menisci | | or if transmitted beam energy is sufficiently low to avoid unintended |
| | | | part damage. |
| | | | Shadowing a potential issue if need to reach down sidewalls |
| | | | High telecentric (low field angle) + full field lens to cover the |
| | | | build area |
| | | | High telecentric (low field angle with sub-build field size) + |
| | | | scanning stage to cover the build area |
| | | | Low telecentric + scanning + complex pattering |
| | | | Multi-module scanning systems. |
| | | | Stringent laser-UV alignment tolerances between part border and |
| | | | laser scanning system. Addition of a machine vision feature may |
| | | | facilitate alignment of the laser with part boundaries. |
| Enable | Cleaning unwanted resin | Ex-situ | Short penetration depth to avoid damaging substrate and printed part |
| washless | on regions of surfaces that | | preferred |
| printing | have undesired contact | | Reduced telecentricity required. |
| | with residual resin on | | Embodiments with advantageously loose laser part alignment |
| | carrier film. | | tolerances. |
| Improved | 1) Remove protruding | In-situ; | If need to cut glass fibers, then CO2 or DUV laser preferred. |
| material | fibers at part surface. | Ex-situ | Through-film methods may be present challenges, depending on |
| properties → | 2) Enable using longer | | choice of film and resin properties. |
| enabled fiber | fibers → better material | | Similar to side wall challenges above. |
| filler | properties | | |
| Improved | 1) Promotion of inter-layer | Ex-situ | Selectively remove polymer and leave glass/filler unmodified |
| material | adhesion of fiber materials | | through use of selective absorption of glass relative to resin in |
| properties by | 2) Selectively remove | | combination with short pulse time exposures. |
| enabling fiber | polymer | | Melt and sinter glass or fillers during or after polymer removal in a |
| filler | 3) Improve Z-toughness, | | second step. |
| | reduce anisotropy. | | Irradiating full part cross section may lead to reduced throughput. |
| Improved | 1) Subtractive removal of | In-situ; | Similar to edge cleaning. |
| accuracy | cured material for | Ex-situ | Longer penetration depth acceptable |
| | delivering precision | | Higher pulse energy to remove solid cured material, relative to |
| | 2) Reduced accuracy | | removing uncured material is likely required. |
| | performance requirements | | |
| | on UV-cure system | | |
| Improved | High temperature in-situ | In-situ; | Full part cross section may lead to throughput issues. |
| material | processing (melt | Ex-situ | |
| properties by | thermoplastics, glass, etc) | | |
| thermal | | | |
| modification of | | | |
| materials | | | |
| Improved | 1) UV cure at edge to | In-situ; | UV laser (actinic exposure) preferred for additional cure of surface. |
| accuracy | reduce mass loss warpage. | Ex-situ | Embodiments with advantageously low telecentricity requirements. |
| | 2) Or removal of low-dosed | | |
| | material | | |
| Improved | Modify surface finish from | Ex-situ | Similar comments as side wall cleaning. |
| surface finish | innate resulting from UV- | | |
| | cure | | |
| Enable | 1) Eliminate unwanted | In-situ | Laser has short penetration depth in resin, but at a wavelength where |
| washless | contact during coating | | carrier film (e.g., FEP) is transparent. Absorption modifiers can be |
| Multi-material | regions of surfaces (e.g., up | | used to achieve the optimal combination of resin absorption in the film |
| Direct writing | upward facing surface) that | | transparency window. |
| with blister | have undesired contact | | Only energy sufficient to vaporize small bubble is needed, hence |
| transfer | with residual resin on | | advantageously reduced pulse energy required compared to ejection or |
| | carrier film “transition” | | ablation. |
| | surfaces | | Likely larger rheological and laser pulse parameter process window |
| | 2)Means for pattern | | compared to ejection transfer. |
| | transfer printing (material | | Full field may lead to throughput challenges |
| | transfer without jetting | | Embodiments with advantageously reduced telecentricity |
| | ejection) | | requirements |
| | 3) Wider process window | | |
| | compared to jet material | | |
| | ejection | | |
| Enable | 1) Eliminate unwanted | In-situ | Laser has short penetration depth in resin, but at a wavelength where |
| washless | contact during coating | | carrier film (e.g., FEP) is transparent. Absorption modifiers can be |
| Multi-material | regions of surfaces (e.g., | | used to achieve the optimal combination of resin absorption in the film |
| Direct writing | upward facing surfaces) | | transparency window. |
| jetting across | that have undesired contact | | Short penetration depth in resin, but FEP transparent. Absorption |
| gap | with residual resin on | | modifiers can be used to achieve the optimal combination of resin |
| | carrier film “transition” | | absorption in the film transparency window. |
| | surfaces. | | Need to eject material from film to transfer across gap between resin |
| | 2) Means for pattern | | film and part likely requires sufficient higher pulse energy compared |
| | transfer printing | | to blister transfer. |
| | | | Likely narrower rheological and pulse parameter process window for |
| | | | effective and controlled material transfer with minimal splatter and |
| | | | satellite droplets, compared to blister transfer. |
| | | | Full field requirements may lead to throughput challenges |
| | | | Embodiments with advantageously reduced telecentricity |
| | | | requirements |
| Enable | Reduce unwanted meniscus | | Efficacy maybe be limited by embodiments and resins properties. |
| washless | through controlling | | |
| printing | wettability | | |

The foregoing is illustrative of the present invention, and is not to be construed as limiting thereof. The invention is defined by the following claims, with equivalents of the claims to be included therein.

1.-3. (canceled)

4. A method of making a three-dimensional object by additive manufacturing, comprising:
(a) applying a light polymerizable resin to a build surface of a growing three-dimensional object to form a build segment, and with said applying carried out with a moving roller resin applicator or a moving film resin applicator;
(b) exposing said build segment to patterned light to polymerize said build segment and form a new build surface,
(c) exposing said new build surface to an ablation light to physically and/or chemically modify said new build surface; and
(d) sequentially repeating steps (a) through (c), with step (c) optionally omitted during some of said sequentially repeating steps but included during at least a plurality of said sequentially repeating steps, until said three-dimensional object is formed.

5. The method of claim 4, wherein said exposing step (c) is carried out at a dosage that textures at least a portion of said new build surface.

6. The method of claim 4, wherein said light polymerizable resin comprises an additive, and said exposing step (c) is carried out at a dosage that selectively melts or sinters said additive in at least a portion of said new build surface and modify the material properties of the three-dimensional object.

7. The method of claim 4, wherein said light polymerizable resin is a dual cure resin comprising a first polymerizable component and a second polymerizable component and said exposing step (c) is carried out at a dosage that initiates polymerization of said second polymerizable component in at least a portion of said new build surface to modify the mechanical properties of said three-dimensional object.

8. The method of claim 4, wherein said exposing step (c) is carried out at a dosage that modifies material properties in at least a portion of said new build surface.

9. The method of claim 4, wherein said exposing step (c) is carried out at a dosage that activates surface chemicals in at least a portion of said new build surface.

10. The method of claim 4, wherein said light polymerizable resin comprises a filler, and said exposing step (c) is carried out at a dosage that selectively expands said filler in at least a portion of said new build surface.

11. The method of claim 4, wherein said light polymerizable resin comprises a filler.

12.-14. (canceled)

15. The method of claim 4, wherein said applying step is carried out with a bottom-up or top-down additive manufacturing apparatus.

16. The method of claim 4, wherein said applying step is carried out with a moving roller resin applicator.

17. The method of claim 4, wherein said applying step (a) is carried out with said moving film resin applicator.

18.-21. (canceled)

22. The method of claim 4, further comprising the steps of:
detecting a current property of said ablation light;
comparing said current property to a desired property and
modifying said ablation light so that said current property more closely corresponds to said desired property.

23. A three-dimensional object produced by the method of claim 4.

24. An apparatus for additively manufacturing a three-dimensional object from a light polymerizable resin, comprising:
(a) a build platform on which a growing three-dimensional object can be produced, the object having a build segment, the build segment including an edge portion and a build surface;
(b) an applicator configured to apply a light-polymerizable resin to said build surface to form a new build segment including a new edge portion and a new build surface, wherein said applicator comprises a moving roller resin applicator or a moving film resin applicator;
(c) a resin supply configured for applying said light polymerizable resin to said applicator;
(d) a first, additive light source configured for polymerizing said light polymerizable resin on said build segment; and
(e) a second, subtractive light source configured for delivering a dosage of light to said edge portion(s) and/or said build surface(s).

25.-26. (canceled)

27. The apparatus of claim 24, wherein said applicator comprises said moving roller resin applicator.

28. The apparatus of claim 24, wherein said applicator comprises said moving film resin applicator.

29.-31. (canceled)

32. The apparatus of claim 4, further comprising:
a detector operatively associated with said subtractive light source and configured to detect a current property of said subtractive light; and
a controller operatively associated with said detector and said subtractive light source, said controller configured to compare said current property to a desired property and modify said subtractive light so that said current property more closely corresponds to said desired property.

33. The apparatus of claim 4, wherein said subtractive light source comprises:
a continuous wave light source or a pulsed laser light source;
a single beam light source or a multi-beam light source,
a free-standing laser or a fiber-optic based laser; and/or
a single wavelength light source or a multi-wavelength light source.

34. The apparatus of claim 4, wherein said subtractive light source further comprises:
a laser trepanning system;
an XY stage for scanning or raster scanning of the laser beam;
a beam expander, mirror, focusing lens, and/or air assist;
a Z focusing component such as a motorized focusing mechanism;
an additional optical element comprising a fiber optic element, diffraction optical elements and/or beam splitter;
a beam focusing elements; and/or
a beam shaping components.

35. A method of fabricating a three-dimensional object by additive manufacturing, comprising:
(a) forming a first three-dimensional object on a build platform;
(b) positioning a resin coated film under the three-dimensional object, optionally wherein a void space is present between the resin coated film and the three-dimensional object;
(c) exposing a portion of the resin coated film to laser radiation sufficient to eject at least a portion of the resin onto a bottom surface of the three-dimensional object;
(d) exposing the resin on the bottom surface of the three-dimensional object with actinic radiation or light to polymerize said resin, and
(e) optionally, sequentially repeating steps (b) through (d), to form a second three-dimensional object.

36.-39. (canceled)
